(19) United States
(12) Patent Application Publication
(10) Pub. No.: US 2025/0054482 A1
(43) Pub. Date: Feb. 13, 2025

(54) METHOD FOR OPERATING A NOISE REDUCTION UNIT

(71) Applicant: Brose Fahrzeugteile SE & Co. Kommanditgesellschaft, Wuerzburg, Wuerzburg (DE)

(72) Inventor: Johannes SCHWARZKOPF, Marktheidenfeld (DE)

(73) Assignee: Brose Fahrzeugteile SE & Co. Kommanditgesellschaft, Wuerzburg, Wuerzburg (DE)

(21) Appl. No.: 18/929,157

(22) Filed: Oct. 28, 2024

Related U.S. Application Data
(63) Continuation of application No. PCT/EP2023/059968, filed on Apr. 18, 2023.

(30) Foreign Application Priority Data
Apr. 28, 2022 (DE) 10 2022 204 180.1

(51) Int. Cl. G10K 11/178

(52) U.S. Cl. CPC G10K 11/17823; G10K 11/17873; G10K 2210/1282; G10K 2210/3011; G10K 2210/3027

(57) ABSTRACT

A method for operating a noise reduction unit of a motor vehicle, which has a noise output device and an active noise cancelling unit. Via the active noise cancelling unit, an active noise cancelling signal is generated on the basis of a received interference frequency of an actuator and other received operating data of the actuator. The noise output device is provided with the same. A noise reduction unit of a motor vehicle is also provided.

This nonprovisional application is a continuation of International Application No. PCT/EP2023/059968, which was filed on Apr. 18, 2023, and which claims priority to German Patent Application No. 10 2022 204 180.1, which was filed in Germany on Apr. 28, 2022, and which are both herein incorporated by reference.

### BACKGROUND OF THE INVENTION

### Field of the Invention

The present invention relates to a method for operating a noise reduction unit, and a noise reduction unit. The noise reduction unit may be a component of a motor vehicle in its intended state.

### Description of the Background Art

Motor vehicles, such as passenger cars, are at least partly used to transport people. The latter are usually located in a passenger compartment of the motor vehicle in which one or more seats are arranged for the persons. During the operation of the motor vehicle, noises are produced which may be perceived as disturbing by persons inside the motor vehicle. It is also possible that such noises, especially if they are comparatively monotonous, lead to premature fatigue of the persons in the passenger compartment. Such noises can also distract a driver of the motor vehicle from what is happening around the motor vehicle, increasing the likelihood of an accident. Such noises occur, for example, when operating an actuator of the motor vehicle, such as an electromotive adjustment drive, i.e., when the electric motor and the components driven by it are rotated or moved in some way. It is also possible that the people mistakenly assume that the actuator is malfunctioning or is of poor quality due to the noise.

In order to reduce such noise, a comparatively complex coordination of the individual components of the electromotive adjustment drives is usually required, which is why design costs are increased. In addition, only comparatively low levels of manufacturing tolerances can therefore be chosen for the individual components, which is why manufacturing costs are increased. It is also possible that, for example, the noise only occurs at certain operating points, so that the operation of the components at these operating points is prevented in order to avoid the noise.

In an alternative, it is provided that a sound in the passenger compartment of the motor vehicle is detected via a microphone and transmitted to an active noise canceling unit of a noise reduction unit. Via this, an active noise canceling signal is generated, which is emitted via a corresponding loudspeaker of the noise reduction unit. The active noise canceling signal is designed in such a way that, after being emitted via the loudspeaker, a destructive inference with the sound prevailing in the passenger compartment takes place in the area of the head of one or more persons in the motor vehicle. It is always necessary that the sound prevailing in the passenger compartment is first detected by the microphone for the active noise canceling signal to be adjusted accordingly. In the event of a change in the existing sound, the corresponding active noise canceling signal is created later, so that at least for a short time no destructive interference takes place. Thus, the noise is perceptible in the passenger compartment for at least a short period of time, which is why comfort is reduced and acoustics in the passenger compartment are worsened.

### SUMMARY OF THE INVENTION

It is therefore an object of the invention to develop a particularly suitable method for operating a noise reduction unit of a motor vehicle as well as a particularly suitable noise reduction unit of a motor vehicle, wherein advantageously comfort is increased and/or resulting acoustics are improved, and wherein suitably manufacturing costs are reduced.

In an example, the method is used to operate a noise reduction unit of a motor vehicle. The motor vehicle is particularly land-based and preferably multi-lane. In this case, it is appropriately possible to position the vehicle essentially freely, in particular on an appropriate roadway. For this purpose, the motor vehicle has, for example, appropriate wheels. In summary, it is preferable to position the motor vehicle essentially independently of other factors on land. In other words, the motor vehicle is appropriately not rail-bound. Preferably, the motor vehicle is a passenger car or a heavy vehicle, such as a truck or bus.

The motor vehicle can have a passenger compartment. The passenger compartment can be suitable, in particular provided and equipped, for persons who are also referred to as occupants, and in particular include a driver of the motor vehicle, to stay in it at least temporarily. When the motor vehicle is moved, the persons in the passenger compartment are also moved. Expediently, an opening in the passenger compartment of the motor vehicle is covered or at least can be covered via a door. Preferably, it is therefore possible to adjust the door with regard to the possible body of the motor vehicle so that the opening is opened up. Thus, it is possible for the person to get into or out of the passenger compartment via the opening. For example, the door can be pivotally and/or transversely adjusted on the possible body of the motor vehicle. For example, the door is a tailgate or, in particular, a side door.

The motor vehicle comprises an actuator. The actuator is used to carry out a specific activity during operation. Suitably, the activity is at least partially repetitive, and/or the actuator preferably includes an electric motor. Particularly preferably, the actuator is or includes an electromotive adjustment drive. The electromotive adjustment drive has an electric motor and an adjustable part driven by it. The electric motor is, for example, a brushed commutator motor or, particularly preferably, a brushless direct current motor (BLDC). For example, the adjustment part is directly driven via the electric motor. However, it is particularly preferable to arrange other components between them, such as a gear, which is designed to be self-locking, for example. In this way, the adjustment part can only be moved when the electric motor is in operation. The gear is preferably a worm gear. Alternatively or in combination with this, another component is mechanically connected between the electric motor and the adjustment part, for example between the gear and the adjustment part. such as a cable drum or a spindle.

When the electric motor is in operation, the adjustment part is moved along an adjustment path, with the adjustment path being curved or straight, for example. In particular, the electromotive adjustment drive has a guide via which the adjustment part is guided, and via which the adjustment path is at least partially predetermined. Preferably, the adjustment path has one or two stops, between which the adjustment part can be moved when the electric motor is in operation. Via the stops, the adjustment part is prevented from adjusting excessively.

For example, the electromotive adjustment drive is an electromotively adjustable glove compartment, and the adjustment part is a glove compartment flap. Alternatively, the adjustment part is a screen, and the electromotive adjustment drive is an electromotive screen adjuster. In another alternative, the adjustment part is a center console or an armrest, and the electromotive adjustment drive is therefore an electromotive-adjustable center console or an electromotive-adjustable armrest. However, most preferably, the electromotive adjustable drive is an electromotive seat adjuster, and the adjustment part is therefore either a complete seat or a part of a seat, such as a backrest, a seat or a headrest. The seat is suitable, in particular provided and configured, for a person in the passenger compartment to sit on it, such as the driver. Thus, the seat is a driver's seat. Alternatively, the seat is a passenger seat. As another alternative, the seat is designed in the style of a bench, for example, and thus has individual seating areas, wherein the seat, i.e., the bench, is suitable as well as provided and configured for accommodating several people, such as two or three. In another alternative, the electric adjustment drive is an electromotive window control or an electromotive door adjuster.

The noise reduction unit includes a noise output device. Suitably, the noise output device is a component of the possible internal space of the motor vehicle, so that the noise output device is protected. The noise output device is, for example, a loudspeaker. The loudspeaker is preferably provided for the emission of sound waves into the passenger compartment of the motor vehicle. The loudspeaker is suitable for this purpose, in particular provided and set up. The loudspeaker is, for example, a so-called subwoofer, a midrange driver or a tweeter or at least includes one or more of them. Alternatively, the noise output device, for example, is suitable as well as provided and set up for the output of structure-borne noise. In other words, the noise output device is used to emit structure-borne noise. For example, the noise output device is made in the manner of a vibrating unit. In particular, the noise output device has an electric motor via which a piston or the like is driven which is mechanically attached to a component, such as a membrane or the like. At least it is possible to apply the structure-borne noise to one or another component via the noise output device.

The noise reduction unit also includes an active noise canceling unit, via which it is possible to generate an active noise canceling signal. The active noise canceling signal generated by the active noise canceling unit is in particular such that an active noise canceling is generated when the active noise canceling signal is emitted via the noise output device. The active noise canceling destructively interferes with an existing sound, especially at a certain location. For example, the location is fixed in the active noise canceling unit or can be adjusted, for example.

The method provides that the active noise canceling signal is generated, i.e., created/determined, and that the noise output device is applied with it. As a result, the active noise canceling signal is emitted via the noise output device and active noise canceling is produced, in particular. In particular, a destructive interference of the active noise canceling takes place with an existing sound at a certain location, wherein the location is particularly determined via the active noise canceling. The active noise canceling signal is generated via the active noise canceling unit using a received interference frequency of the actuator. The interference frequency is transmitted in particular via a message to the active noise canceling unit, so that it is received. In particular, the active noise canceling unit has a corresponding input to receive the interference frequency. Preferably, the interference frequency is transmitted to the active noise canceling unit via a bus system of the motor vehicle so that it can be received by the active noise canceling unit. In summary, the interference frequency is not directly measured via the active noise canceling unit or any other component of the noise reduction unit.

For example, the interference frequency is provided directly by the actuator or, for example, by an on-board computer. In particular, the interference frequency is stored in the actuator, for example depending on the actuator's operation. For example, the interference frequency was determined on the basis of a theoretical model or on a test bench, for example in the production of the motor vehicle. The interference frequency corresponds in particular to the frequency of sound waves emitted when the actuator is in operation. The sound is undesirable and could lead to disturbing possible persons. In summary, in particular, the interference frequency corresponds to the frequency of the undesirable sound emitted during operation of the actuator. For example, the interference frequency is only a single frequency or includes, for example, other frequency ranges or frequency bands. Alternatively, the active noise canceling signal is generated using multiple such interference frequencies. In particular, double frequencies are available, so that so-called harmonic waves or ripple harmonics are taken into account.

Furthermore, the active noise canceling signal is generated, i.e., determined, on the basis of other operating data received from the actuator. The operating data are derived, for example, from the operation of the actuator or correspond to certain states of the actuator. The operating data of the actuator are also not measured via the noise reduction unit, but are provided, for example, by the actuator. The operating data are expediently transmitted by signal to the active noise canceling unit, in particular directly from the actuator, preferably via the possible bus system. In other words, the operating data are sent via the possible bus system of the motor vehicle to the noise reduction unit. Appropriately, the reception of the interference frequency and the operating data is carried out in a single step, and these are contained, for example, in a common message/notification which is produced in particular via the actuator.

In summary, the active noise canceling signal is therefore at least generated on the basis of data resulting from the operation of the actuator, which are not measured directly, for example. The interference frequency and operating data are thus already available when the actuator starts operation in accordance with the operating data and/or when the actuator starts operation, so that the operating data will be obtained. Consequently, it is possible to create the active noise canceling signal before the sound is emitted by the actuator. Consequently, it is possible, and is purposefully carried out, to output the active noise canceling based on the active noise canceling signal at essentially the same time as the sound, or at least at a time so that the destructive interference takes place at a certain location. In other words, the destructive inference is essentially instantaneous and there is no need for a subsequent regulation. As a result, noise pollution for people using the motor vehicle is reduced, thus increasing comfort and improving acoustics.

In summary, the active noise canceling signal is produced in particular via the active noise canceling unit in such a way that in the event of a superposition of the sound which has the interference frequency, or at least results with the interference frequency because of the operation of the actuator, a destructive interference occurs with the active noise canceling corresponding to the active noise canceling signal, so that the original sound is at least partially attenuated. In particular, the operating data are selected in such a way that they can be used to specify, and/or at least determine therefrom, a phase position of the interference frequency and/or an amplitude of the sound emitted via the actuator, which has the interference frequency. In this way, it is possible to essentially completely cancel out the sound generated during operation of the actuator via the active noise canceling. The active noise canceling signal is particularly preferably generated on the basis of the interference frequency and the other operating data of several actuators. Thus, noise reduction is further improved, wherein despite having several actuators, only a single noise reduction unit is required per motor vehicle. Therefore, manufacturing costs are reduced.

For example, the active noise canceling signal is generated on the basis of the interference frequency and the operating data with the help of a theoretical model, which is stored in the active noise canceling unit, for example. Alternatively, for example, a map is stored in the active noise canceling unit in which the active noise canceling signal is stored depending on the interference frequency and/or the operating data. However, a neural network or other “artificial intelligence” algorithm is particularly preferred for determining the active noise canceling signal on the basis of the interference frequency and the operating data. Thus, it is only required that the neural network be trained. For example, this is already fully trained when the noise reduction unit is installed in the motor vehicle or used there for the first time. Alternatively, training is carried out after assembly in the motor vehicle, so that adaptation to the respective motor vehicle is improved. It is particularly preferable to renormalize or adapt the neural network at certain time intervals, which are particularly constant. For example, the ageing effects of the actuator are taken into account, so that consistent acoustics are guaranteed for the entire operating time of the motor vehicle.

For example, the active noise canceling signal is determined and thus generated solely on the basis of the interference frequency and the operating data. In this way, the method is feasible with few hardware resources and comparatively robust. However, it is particularly preferred to also capture a sound signal, which is used to generate the active noise canceling signal. The sound signal was generated in particular via a microphone, via which a sound is measured and converted to the sound signal. Preferably, the microphone is a component of the noise reduction unit or at least connected by signal, for example via the bus system. In particular, the microphone is arranged in the possible passenger compartment, or at least the sound is preferably measured via the microphone in the passenger compartment.

It is thus possible that, despite the output active noise canceling, for example due to manufacturing tolerances, a modified configuration of the passenger compartment, . . . , noise, i.e., sound, can still be present due to the operation of the actuator at which the destructive interference is to take place. This is measured at least implicitly via the microphone, so that the active noise canceling signal can subsequently be adjusted accordingly. Thus, noise pollution in the passenger compartment is further reduced. In particular, the interference frequency as well as the operating data are used to carry out a pilot control, and via the microphone, components of the sound that continue to exist are detected as sound signals, so that the active noise canceling signal is subsequently adapted in such a way that a complete or at least improved destructive interference occurs. Thus, comfort is further enhanced.

However, it is also possible that the sound signal generated by the microphone is based on sound that is independent of the actuator. This sound is, for example, wind and/or driving noise. Consequently, these noises are at least partially suppressed via the active noise canceling, which is why comfort is further increased.

For example, the interference frequency corresponds to an excitation frequency of a component driven by the actuator, such as a possible adjustment part. Particularly preferred, however, a speed of the actuator, in particular of the actuator's electric motor, is used as the interference frequency. In particular, the speed is used to control or regulate the actuator and is measured for this purpose, for example. Alternatively, a target speed is set as the speed on the basis of which the actuator is operated. Thus, fewer sensors are required.

For example, a position of the actuator is used as operating data, i.e., in particular position information. In one variation, the position corresponds to the position of a component driven by the actuator, such as the possible adjustment part. However, the position is particularly preferred to correspond to the position of a rotor of the possible electric motor of the actuator, in particular with respect to a stator. In other words, the position preferably corresponds to angular information. Thus, the determination of a phase position of the sound emitted by the actuator, i.e., the sound waves, is facilitated.

Alternatively, or particularly preferably, in combination with this, a power parameter of the actuator is used as operating data. The power parameter is in particular the power applied or absorbed via the actuator. In another alternative, the power parameter is a torque or the force applied via the actuator. In another alternative, the power parameter corresponds to an acceleration of the actuator. For example, the power parameter is measured via a corresponding sensor of the actuator and thus provided via the actuator. Alternatively, the power parameter is derived on the basis of an actuator control and preferably provided via the control.

In this context, the power parameter is in particular the current power parameter, i.e., the current power parameter provided or realized via the actuator. As compared to detecting the sound via the microphone, the current power parameter is already available as soon as it is realized via the actuator, i.e., at the moment in which the sound is emitted. Alternatively, the power parameter is the expected power parameter of the actuator, i.e., the one which will be realized in a certain period of time, for example. Thus, the period of time for the creation of the active noise canceling signal is increased, and the active noise canceling can be emitted in accordance with the resulting sound, so that the complete destructive interference takes place. Preferably, the expected power parameter is used to control the actuator. In order to capture the expected power parameter, for example, a map or the like is read out. The use of the expected power parameter also makes it possible to adapt the active noise canceling signal to a changing operation of the actuator. Furthermore, it is possible to use comparatively low-performance hardware to create the active noise canceling signal, which reduces manufacturing costs. Preferably, both the current and the expected power parameter are used to generate the active noise canceling signal, which further improves the quality.

In another alternative, electrical operating data of the actuator are used as operating data. The electrical operating data corresponds preferably to the control data of the actuator, i.e., to data via which the actuator is controlled. In particular, the electrical operating data and thus the control data correspond to an electrical voltage applied to the actuator. Alternatively or in combination with this, a commutation mode of the actuator's possible electric motor is used as electrical operating data. For example, this is a sine commutation, an overmodulation or a block commutation. Alternatively or in combination with this, the electrical operating data indicate whether the electric motor is operated in the basic speed range or in the field weakening range. As a result, the operating data is already available a comparatively large period of time in advance, and/or it is used for additional functions, so that no additional components are required to determine the operating data, which is why manufacturing costs are reduced.

In another alternative, for example, a temperature of the actuator is used as operating data. For example, the temperature is the average temperature of the actuator or part of the actuator, for example of the possible electric motor. In particular, the temperature is the temperature of a stator winding or a bearing of the electric motor. In another alternative, the temperature is, for example, the temperature of a fluid of the actuator, such as a lubricant or a liquid pumped via the actuator. Thus, in particular, a changing viscosity/resistance, either of which lead to a change in the behavior of the actuator, is taken into account when creating the active noise canceling signal.

Expediently, the time of determination of the interference frequency is used as operating data. In particular, as long as the operating data include other data, such as the temperature, electrical operating data, power parameter and/or the position, the respective time of determination or at least an associated point in time is used as another component of the operating data. Thus, even with different transit times for the transmission of the interference frequency, a coordinated creation of the active noise canceling signal is still possible, so that the effectiveness of destructive interference is improved. Preferably, a phase position of the active noise canceling signal is determined on the basis of the time of determination.

In its intended state, the noise reduction unit is a component of a motor vehicle and suitable, expediently provided and equipped for this purpose. The motor vehicle is particularly land-based, and for example a truck, bus or preferably a passenger car.

The noise reduction unit has a noise output device which is used in particular to output sound into a passenger compartment of the motor vehicle. For example, the noise output device is a loudspeaker or includes it. Via this, sound is emitted into air during operation, namely sound waves that travel through the air. Alternatively, the noise output device is a structure-borne noise output device via which a component is excited during operation so that it vibrates. Via the component or another component coupled with it, sound is subsequently emitted, which corresponds to the sound applied via the structure-borne noise output device. For example, the noise output device is only assigned to the noise reduction unit. Alternatively, the noise output device is also used by other components of the motor vehicle when in operation, in particular by a radio or other multimedia playback unit.

The noise reduction unit also includes an active noise canceling unit. For example, the active noise canceling unit is at least partially formed via a software routine or certain electrical and/or electronic components. The active noise canceling unit is expediently coupled by signal to the noise output device. Preferably, the active noise canceling unit is coupled by signal with an on-board computer of the motor vehicle or at least an actuator of the motor vehicle, in particular an electromotive adjustment drive, in the state of assembly. For this purpose, the active noise canceling unit preferably has a corresponding data interface, which is suitable for a bus standard. In particular, a slave control unit of the bus system is formed via the active noise canceling unit.

The noise reduction unit is operated according to a method for operating a noise reduction unit. In the method, an active noise canceling signal is generated via the active noise canceling unit based on a received interference frequency of the actuator and other actuator operating data received, and the noise output device is acted upon. The active noise canceling unit appropriately has a control unit via which the method is carried out, at least in part. The control unit is suitable for this purpose, in particular provided and configured. The control unit, or at least the active noise canceling unit, includes, for example, an application-specific integrated circuit (ASIC) or, in particular, a computer that is suitably programmable. In particular, the control unit or at least the active noise canceling unit includes a storage medium on which a computer program product, also known as a computer program, is stored, wherein when this computer program product, i.e., the program, is executed, the computer is prompted to perform the method.

The invention also relates to a computer program product. The computer program product comprises a number of commands which, when the program (computer program product) is executed by a computer, prompt it to operate, at least in part, a method for operating a noise reduction unit of a motor vehicle which has a noise output device and an active noise canceling unit. In this method, an active noise canceling signal is generated via the active noise canceling unit on the basis of a received interference frequency of an actuator and other received operating data from the actuator, thus acting upon the noise output device. The computer is expediently a component of a control unit and, for example, formed via it. The computer preferably comprises a microprocessor or is formed via it. For example, a computer program product is a file or disk that contains an executable program that, when installed on a computer, automatically performs the method.

The invention also relates to a storage medium on which the computer program product is stored. Such a storage medium is, for example, a CD-ROM, a DVD or a Blu-Ray Disc. Alternatively, the storage medium is a USB stick or other storage device that is, for example, re-writable or only writable once. Such a storage medium is, for example, a flash memory, a RAM or a ROM. The invention also concerns a control unit for carrying out the method, which is therefore suitable, in particular provided and set up for this purpose. The invention also relates to a motor vehicle with such a noise reduction unit.

The further developments and advantages explained in connection with the method can be transferred analogously to the noise reduction unit/the computer program product/the storage medium/the control unit/the motor vehicle as well as to each other, and vice versa.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows in a side view, schematically a motor vehicle with a noise reduction unit; and

FIG. 2 shows a method for operating the noise reduction unit.

### DETAILED DESCRIPTION

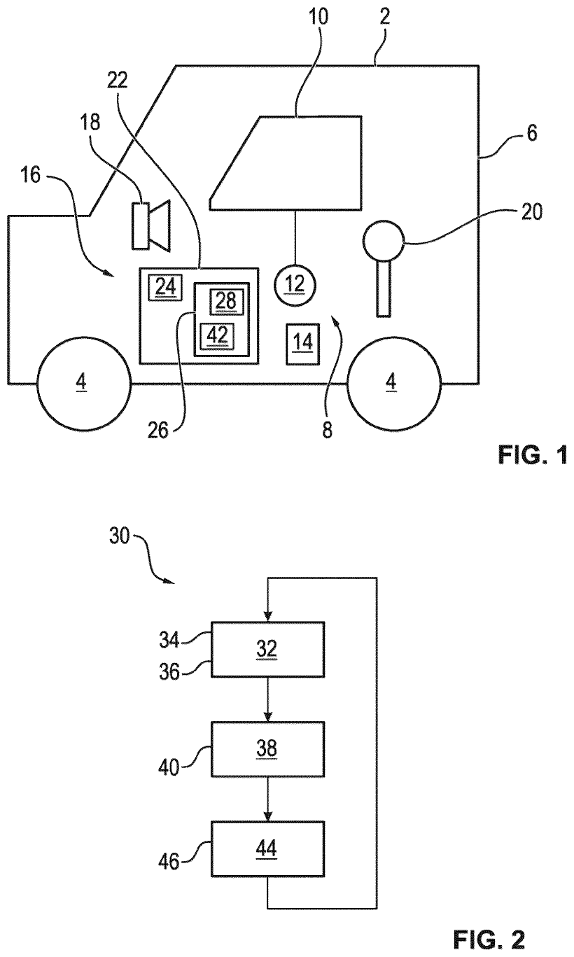

FIG. 1 shows a motor vehicle 2 schematically simplified in the form of a passenger car. The motor vehicle 2 comprises several wheels 4, at least some of which are driven by a drive and which are standing up on a road surface in their intended state. The wheels 4 are connected to a body 6 of the motor vehicle 2 via a chassis, via which a passenger compartment is surrounded, which serves to house persons.

On the body 6 is an actuator 8 in the form of an electromotive adjustable drive. The actuator 8 is designed as an electric window control and has a window pane 10 which forms an adjustment part, which is driven via an electric motor 12 of the actuator 8 via a drive and a cable drum. The actuator 8 also includes a control system 14 via which the electric motor 12 is energized depending on certain requirements, so that the window pane 10 is moved in a desired direction and at a desired speed. For this purpose, the speed of the electric motor 12 is recorded via the control system 14 and regulated to a desired target speed as the target value, wherein the target value depends on the position of the window pane 10 and other specifications. In summary, the control system 14 regulates the electric motor 12.

It is possible that due to the operation of the electric motor 12, sound is produced, which enters the passenger compartment of the motor vehicle 2 and leads to a disturbance of the persons in it. To remedy this, the motor vehicle 2 has a noise reduction unit 16 with a noise output device 18. The noise output device 18 is a loudspeaker positioned in the passenger compartment of the motor vehicle 2. The noise output device 18 is used in another operating mode by a multimedia playback unit, so that music or the like can also be output via the noise output device 18 if required.

Also positioned in the passenger compartment of the motor vehicle 2 is a microphone 20 of the noise reduction unit 16, via which the noise predominant in the passenger compartment can be measured and thus recorded. The noise output device 18 and the microphone 20 are signal-connected via unspecified cables to an active noise canceling unit 22 of the noise reduction unit 16, which forms a control unit of the noise reduction unit 16. The active noise canceling unit 22 is signal-connected to the actuator 8, namely the control system 14, via a bus system as well as to an unspecified on-board computer of the motor vehicle 2.

The active noise canceling unit 22 comprises a computer 24 in the form of a programmable microprocessor and a storage medium in the form of a memory 26. A computer program product 28 is stored in the memory 26, which, when executed by the computer 24, prompts it to carry out a method 30 for the operation of the noise reduction unit 16 shown in FIG. 2. In other words, the noise reduction unit 16 is operated according to the method 30.

In a first step 32, an interference frequency 34 of the actuator 8 and operating data 36 are received via the active noise canceling unit 22. The interference frequency 34 as well as the operating data are provided by the control system 14 of the actuator 8 and fed into the bus system, so that they can be received via the active noise canceling unit 22. The interference frequency 34 corresponds to the speed of the actuator 8, i.e., the speed of the electric motor 12. For this purpose, the target speed is provided via the control system 14 to which the electric motor 12 is regulated in accordance with the specifications.

A temperature of the actuator 8, namely of the electric motor 12, is used as operating data 36. The temperature of the electric motor 12 hereby corresponds to the temperature of an unspecified stator winding of the electric motor 12, which is measured via an unspecified sensor to ensure operational safety and evaluated via the control system 14. The time of determination of the interference frequency 34, i.e., of the speed of the electric motor 12, is also used as operating data 36. The time at which the electric motor 12 is to be set to the target speed is used as the determination time.

In addition, a current power parameter of the actuator 8 at the time of determination is used as operating data 36, namely the torque to be applied at the time of determination. Also, an expected power parameter of the actuator 8 is used as operating data 36, namely the power of the electric motor 12 which is expected or will result from the control via the control system 14. An expected acceleration of the actuator 8, i.e., of the window pane 10, is also used as the expected power parameter. Also for the portion of the operating data 36 which corresponds to the current power parameter, the date of determination is used as another component of the operating data 36, which differs in particular from the time of determination of the interference frequency 34.

In addition or alternatively, electrical operating data of the actuator 8, namely a commutation mode of the electric motor 12, are used as operating data 36. In this case, the electrical operating data are used to specify whether the electric motor 12 is currently being operated in the basic speed range, in field weakening, in sine commutation, in overmodulation or block commutation, i.e., at the current time. A position of the actuator 8 is also used as operating data 36. The position used is the position of the window pane 10 along the adjustment path and the position of the rotor of the electric motor 12 with respect to its stator, so that one of the positions is an angular position.

In summary, the operating data 36 correspond to a vector comprising the position of the actuator 8, the current or expected power parameter of the actuator 8, the electrical operating data of the actuator 8, the temperature of the actuator 8 and several determination times, wherein the determination times differ and are in each case assigned to different other components of the operation data 6. The interference frequency 34 and the operating data 36 are each received via the active noise canceling unit 22.

In a subsequent second step 38, the interference frequency 34 and the operating data 36 are used to generate an active noise canceling signal 40 via the active noise canceling unit 22. Here, for example, the interference frequency 34 is used as the frequencies of the active noise canceling signal 40. The phase as well as the amplitude of the active noise canceling signal 34 are determined on the basis of the operating data 36. To generate the active noise canceling signal 40, a neural network 42 stored in the memory 26 is used, to which the interference frequency 34 and the operating data 36 are supplied.

The active noise canceling signal 40 generated in this way is directed to the noise output device 18, so that the noise output device 18 is acted upon via the active noise canceling signal 40. As a result, an active noise canceling based on the active noise canceling signal 40 is emitted and thus generated via the noise output device 18. The active noise canceling is directed into the passenger compartment of the motor vehicle 2 and spreads out in it. The active noise canceling created in this way interferes with the sound already present in the passenger compartment of the motor vehicle 2, which is created at that moment due to the operation of the actuator 8, i.e., mainly the electric motor 12, and includes at least part of the interference frequency 34.

The active noise canceling signal 40 is created in such a way that in the area of the head of the driver of the motor vehicle 2 there is a destructive interference of the sound produced by the operation of the actuator 8 and of the active noise canceling, so that the operation of the actuator 8 is not perceived by the driver or only to a lesser extent.

In a subsequent third step 44, the sound prevailing in the passenger compartment of the motor vehicle 2 is measured via the microphone 20 and a sound signal 46 is generated on this basis, which is transmitted to the active noise canceling unit 22. In other words, the sound signal 46 is recorded by the active noise canceling unit 22. The sound measured by the microphone 20 is generated due to the superposition of the sound emitted by the actuator 8 with the active noise canceling emitted by the noise output device 18. It is possible that due to manufacturing tolerances or objects in the passenger compartment in the area of the driver's head, there is no complete destructive interference, so that the driver can still hear noises. In particular, these are measured directly via the microphone 20, which is preferably positioned in a headrest of the driver's seat for this purpose. The microphone 20 is also used to measure other noises which do not arise due to the operation of the actuator 8, for example wind or other driving noises, so that the sound signal 46 also corresponds to them.

Subsequently, the first step 32 and the second step 38 are again performed, wherein now in the second step 38, the active noise canceling signal 40 is also generated on the basis of the sound signal 46. Thus, the sound signal 46 updates the creation of the active noise canceling signal 40, i.e., the operating data 36 and the interference frequency 34 are used for the pilot control to create the active noise canceling signal 40, which is created on the basis of the sound signal 46. If the active noise canceling is now output via the noise output device 18, further noise is suppressed due to the improved destructive inference, so that comfort for the driver is increased.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed:

1. A method for operating a noise reduction unit of a motor vehicle, which has a noise output device and an active noise canceling unit, the method comprising:
generating an active noise canceling signal via the active noise canceling unit based on a received interference frequency of an actuator and other received operating data of the actuator; and
acting upon the noise output device.

2. The method according to claim 1, wherein a sound signal is detected, on the basis of which, the active noise canceling signal is also generated.

3. The method according to claim 1, wherein a speed of the actuator is used as the interference frequency.

4. The method according to claim 1, wherein a position of the actuator is used as operating data.

5. The method according to claim 1, wherein a current or expected power parameter of the actuator is used as operating data.

6. The method according to claim 1, wherein the operating data are the electrical operating data of the actuator.

7. The method according to claim 1, wherein a temperature of the actuator is used as operating data.

8. The method according to claim 1, wherein a time of determination of the interference frequency is used as operating data.

9. A noise reduction unit of a motor vehicle comprising a noise output device and an active noise canceling unit, and which is operated according to the method according to claim 1.
